(19) United States
(12) Patent Application Publication
(10) Pub. No.: US 2021/0107025 A1
(43) Pub. Date: Apr. 15, 2021

(54) Lawn Sprinkler Head Dog Protector

(71) Applicant: Rodney Martinez Chavez, Moorpark, CA (US)

(72) Inventor: Rodney Martinez Chavez, Moorpark, CA (US)

(21) Appl. No.: 17/001,820

(22) Filed: Aug. 25, 2020

Related U.S. Application Data
(60) Provisional application No. 62/973,592, filed on Oct. 15, 2019.

(51) Int. Cl. B05B 15/14; A01G 25/00

(52) U.S. Cl. CPC B05B 15/14; A01G 2025/003; A01G 25/00

(57) ABSTRACT

A lawn sprinkler head protector that is made with a hardened concrete material. The shape of the sprinkler protector creates a housing for the sprinkler head to reside in. The hardened concrete material provides the proper weight for the sprinkler head protector to not be dug up out of the ground by a dog. The round shape of the sprinkler head protector is made in a polymer cast. This round shape makes it more difficult for a dog to dig up when buried in dirt.

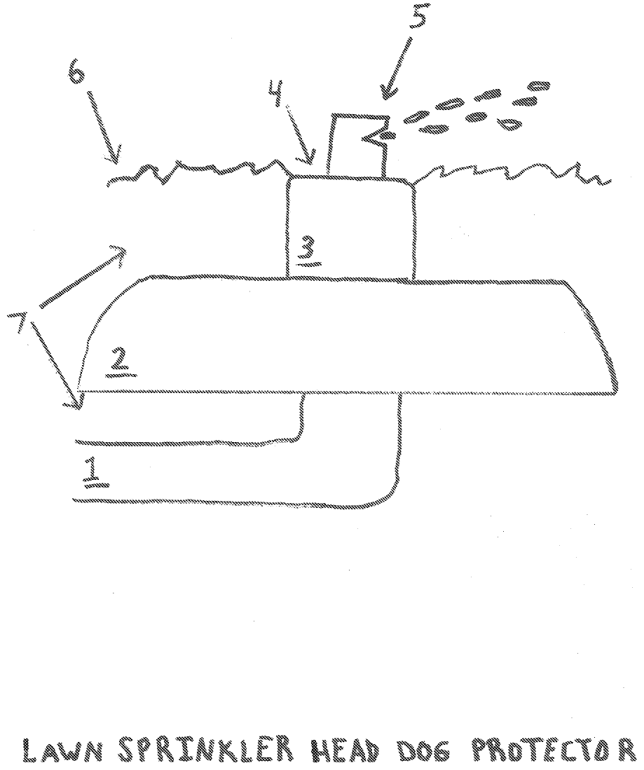

### BACKGROUND OF INVENTION

The invention, Lawn Sprinkler Head Dog Protector, was invented to fulfill a need that is lacking in the consumer lawn care industry. This need is to prevent a dog from digging up lawn sprinkler heads buried in the ground. Some attempted solutions in the past have tried to protect the sprinkler head in certain ways, but the available products on the market do not address a dog digging them up and thus destroying them. A dog sees a sprinkler head as a chewable object and digging it up is a temptation that cannot be passed up. Once a dog starts digging up sprinkler heads it will continue the behavior. To a property owner this means having to buy and install replacement sprinklers. The potential for water waste is great until the property owner realizes the end of the PVC pipe is missing the sprinkler head and it must be replaced. Most watering is done during sleeping hours so it could be some time before the water waste is discovered which means a more expensive water bill for the property owner. Having sprinkler heads destroyed by a dog can be a costly and time-consuming problem for a property owner. The Lawn Sprinkler Head Dog Protector invention will protect the sprinkler head from being dug up by a dog. The Lawn Sprinkler Head Dog Protector will accomplish this by being a safe housing for the sprinkler head to reside in and being constructed in a way that prevents a dog from digging it up.

### BRIEF SUMMARY OF THE INVENTION

The Lawn Sprinkler Head Dog Protector is a new design concept in lawn sprinkler head protection. This current art will be used in the lawn care industry. It is created with the purpose of protecting an inground sprinkler head from being dug up by a dog. The Lawn Sprinkler Head Dog Protector does this by providing a safe housing that the sprinkler head resides in. The design of the current invention prohibits a dog from digging it up, thus keeping the sprinkler head safe inside. The Lawn Sprinkler Head Dog Protector combines three elements that make this possible: the hardened concrete material used to make the invention, the weight of the invention, and the unique round design of the base.

The physical material that will be used to manufacture the Lawn Sprinkler Head Dog Protector will be concrete. A dog sees concrete as an inorganic material. A dog responds to this current art form the same as it responds to a rock, sidewalk, or any other concrete object. Dogs have little interest in digging up or chewing on concrete. Concrete does not have an alluring smell that will hold a dog's attention. Another benefit of using concrete is it works great outdoors to withstand the elements as well as absorbing any sudden impacts that may occur in an outdoor setting such as would happen with lawn equipment. When initially installed in the ground, the Lawn Sprinkler Head Dog Protector may be curious to a dog, but the concrete coupled with the weight and round base design will quickly deter a dog from becoming obsessed with digging it up.

The weight of the Lawn Sprinkler Head Dog Protector is very important to the success of the invention. Dogs will typically pick objects up with their teeth. At times, they may also manipulate objects with their paws. Dogs will normally pick up balls, sticks, dog toys, and other such objects, but will not generally pick up a piece of concrete. When the Lawn Sprinkler Head Dog Protector is in place, it sits buried in a hole with dirt on top of it. On top of this dirt is a layer of grass. With the combined weight of the concrete and buried weight of the invention, it is not likely that a dog would dig it up. However, in the unlikely event it would try, there is a final line of defense that the Lawn Sprinkler Head Dog Protector employs.

The unique round base design would make it virtually impossible for a dog to get at the sprinkler head even if it were to remove all the surrounding grass and dirt. The large round area of the base makes it a stable platform that cannot be toppled by a dog. A dog does not have opposing thumbs so it cannot grab the base to flip it. The smooth curvature of the base also does not give the dog a solid point to manipulate the invention. In a field test, the dog simply ended up scratching its nails on the concrete before abandoning its efforts to dig up the Lawn Sprinkler Head Dog Protector to get to the sprinkler head housed inside. With the current design employing the concrete material, proper weight, and round base design, it is sure to provide a safe housing for a sprinkler head.

### BREIF DESCRIPTION OF THE DRAWING

### Side View of the Invention

### DETAILED DESCRIPTION OF THE INVENTION

The current sprinkler head protectors in the market are designed to protect sprinkler heads from being stepped on by people, grass growing over the sprinkler head or lawn equipment running over them. The current products generally sit over the sprinkler head or around them like a donut on the grass layer. A dog can dig these up with little or no effort, thus reveling the underlying sprinkler head. A dog is able to do this because the current products on the market are not designed with a dog mind.

The Lawn Sprinkler Head Dog Protector is a new design in protecting sprinkler heads. By extending protection from a dog to the sprinkler head, a new product for the market has been created. The Lawn Sprinkler Head Dog Protector will now provide protection to sprinkler heads from dogs and still provide the same protection as current products on the market. This is a big improvement on the current products on the market. It does this by incorporating three elements: the correct type of hardened concrete material, the proper weight of the hardened material, and the unique round base design of the invention. These three elements create an object that isn't alluring to a dog and is such that a dog cannot physically manipulate the object due to the weight of the object and the design of base. A dog will not desire or be able to dig up the Lawn Sprinkler Head Dog Protector, thus protecting the sprinkler head housed inside.

### The Physical Appearance

The Lawn Sprinkler Head Dog Protector is a one-piece object consisting of three sections as illustrated in the following elements: the base 2, the stem 3, and the central opening 4. The base and stem will be round. This is the preferred embodiment for the Lawn Sprinkler Head Dog Protector. Although other shapes such as squares, rectangles, or any other geometrical shape would work. Round is the preferred embodiment. The round design gives the fewest angles for a dog to grab onto if the dog chose to disturb the Lawn Sprinkler Head Dog Protector. A round shape is easier to bury. A round hole is easier to dig around a buried sprinkler head as opposed to a hole with different angles. The diameter of the base will serve to stabilize the Lawn Sprinkler Head Dog Protector in the hole keeping the dog from tipping it over. Although many measurements will meet this goal, the Lawn Sprinkler Head Dog Protector will utilize a ten-inch diameter base. In the field test ten inches where adequate to keep the dog from tipping over the unit. The height of the base will be two and a half inches. Although many base heights would work, this height is adequate to provide the proper strength integrity for the base of the Lawn Sprinkler Head Dog Protector. The vertical shape of the base will be one that offers the ideal weight to base ratio to provide the protection from tipping. The ten-inch base diameter will taper as it rises vertically to measure eight and a half inches in diameter at the top of the base surface creating a trapezoidal shape. The vertical rise of the base will be a curved smooth surface to provide less grip for a dog. The height of the stem will be three and a half inches giving the Lawn Sprinkler Head Dog Protector a total height of six inches. The diameter of the stem will be two and a half inches creating a central opening as illustrated in element 4 that will accommodate most commercial or residential sprinkler heads. This central opening is where the sprinkler head will reside and allow the sprinkler head nozzle to pop up, as illustrated in element 5, when the irrigation system is activated. The concrete wall of the stem will be a half inch thick to protect the Lawn Sprinkler Head Dog Protector from impacts caused by lawn equipment or someone stepping on it. The overall weight of the Lawn Sprinkler Head Dog Protector will be such that a dog cannot pick it up with its teeth or move it with its paws. Although many weight values will meet this need, the Lawn Sprinkler Head Dog Protector will weigh thirteen pounds. This is the ideal weight so it will not put undue pressure on the PVC pipe that will rest under it once installed as illustrated in element 1. Thirteen pounds is also ideal so that a healthy person can easily lift it into place.

### Manufacturing Process

The manufacturing process will borrow techniques from the concrete polymer cast molding industry. A commercial grade polymer will be used to create molds that will hold enough concrete to have a weight of thirteen pounds and produce the units with the correct shape of the Lawn Sprinkler Head Dog Protector. If a customer wants a different shape for the base a different cast can be created. For example, a customer may require a corner or side base as opposed to a round base. Initially, the invention will be produced in the round shape. Concrete is the material of choice for the manufacturing process. Concrete is readily available and mixes easily on site. Concrete can come premixed from a local supplier as needed. Other materials such as steel, plastic cement, ceramic, or any other material would work in theory but are not very practical. They are more costly and overly heavy. These materials require more expensive tools and machinery to fabricate. In the case of steel for example, it will rust when left outdoors. Concrete fixtures are well known to homeowners. Dogs are not attracted to it. No offensive odor additives need to be added to the concrete mix to deter dogs.

The polymer mold will be prepared for the concrete to be poured into. A coat of releasing agent will be applied to the inside of the mold so that the hardened concrete will easily be taken out of mold once hardened. The concrete will be poured into the mold and left undisturbed at room temperature of 68 to 77 degrees Fahrenheit for forty-eight hours to allow it to set. After forty-eight hours, the hardened concrete piece will be removed from mold and moved to a separate location where it will sit for twenty days to allow it to cure completely. In this location, it will be sprayed lightly with water twice a day to aid in the curing process. After the twenty-day period the concrete unit is spray painted green to closely match the color of grass. The paint will be allowed to dry for twenty-four hours. Once the painted unit is dried completely, it is ready to be packed and shipped to an awaiting customer.

### Customer Installation Process

An irrigation PVC pipe of a properly installed watering system is buried at a depth of six to eight inches in the ground. The end of the PVC pipe has the sprinkler head attached with threaded connections. This allows the sprinkler head to lay buried with the top of the sprinkler head showing at grass level. When the irrigation system is activated, the sprinkler head pop-up nozzle will appear above grass level three to four inches high to water the lawn.

Installing the Lawn Sprinkler Head Dog Protector should not disturb this setup. A person installing the Lawn Sprinkler Head Dog Protector will need only a small handheld shovel. A round hole six inches deep and ten and a half inches in diameter will need to be dug around the sprinkler head. This will make the hole just above the underlying PVC pipe as illustrated in element 1. The installer will want to make sure a layer of dirt, as illustrated in element 7, is left between the PVC pipe and the Lawn Sprinkler Head Dog Protector. The installer will place the Lawn Sprinkler Head Dog Protector into the hole and guide the sprinkler head through the central opening so that it is housed in the central opening when the unit settles in the hole. The installer will want to make sure the top of the sprinkler head does not protrude out of the top of the stem. It should be just below the top surface of the stem at a depth of a half inch to one inch. The installer may need to add or take away dirt from inside the hole to accomplish this. At this stage the dirt can be placed back into the hole, thus burying the Lawn Sprinkler Head Dog Protector. When properly buried the only part of the Lawn Sprinkler Head Dog Protector exposed will be the top circular surface of the stem at the grass level as illustrated in element 6. If one were to look into the stem, the top of the sprinkler head pop-up nozzle will be seen housed safely inside.

### Post Install

When this process is completed and the irrigation system is energized, one should see the pop-up sprinkler head pop-up out of the central opening and begin to water the lawn through the nozzle. When the watering time has elapsed and the irrigation system has de-energized, the pop-up nozzle will retract back into the Lawn Sprinkler Head Dog Protector. Once this is accomplished the installation process is completed and the sprinkler head is now protected from this point on.

1. A physically strong and correctly structured object consisting of three elements
a) the necessary concrete material used to make said object fulfills the integrity need of said object
b) the weight of said object fulfills the proper weight requirements of invention
c) the correct round shape measurement of the base of said object is such that it fulfills the base design requirement for stability
whereby a hardened material with the proper weight and proper round base design of said object will protect an inground sprinkler head from being dug up by a dog.
